(19) United States
(12) Patent Application Publication
(10) Pub. No.: US 2017/0076401 A1
(43) Pub. Date: Mar. 16, 2017

(54) PAYMENT SYSTEM WITH AUTOMATED PAYROLL DEDUCTION

(71) Applicant: PerPay, Inc., Philadelphia, PA (US)

(72) Inventors: Christian DiMarco, Philadelphia, PA (US); Arik Misler, Philadelphia, PA (US)

(21) Appl. No.: 15/268,232

(22) Filed: Sep. 16, 2016

Related U.S. Application Data
(60) Provisional application No. 62/219,366, filed on Sep. 16, 2015.

(51) Int. Cl. G06Q 40/00; G06Q 20/10

(52) U.S. Cl. CPC G06Q 40/125; G06Q 20/102

(57) ABSTRACT

A payment platform that allows a user to submit a current pay stub and bank account information and, through the system borrow money, shop online, and complete repayment through automated payroll deduction. The platform includes several modules including (i) a mechanism for collecting repayment, (ii) an accounting system for reconciling payroll repayment, and (iii) a lending engine that performs risk analysis, fraud protection, and makes lending decisions. The payment platform can be merged or accessed through existing merchant e-commerce websites and tied into the checkout process

### RELATED APPLICATION

This application is related to and claims priority from U.S. Provisional Application 62/219,366, filed Sep. 16, 2015, the disclosure of which is incorporated herein by reference in its entirety,

### FIELD OF THE INVENTION

The present invention is directed to a payment system based on automated payroll deduction.

### BACKGROUND

Current lending decisions and payment systems are generally based on assessing a purchaser's ability to pay potential or new purchases based on a person's credit worthiness. Many of those systems include risk thresholds that are based on the purchaser's credit history and financial ability to pay based on data accumulated from past transactions. In many cases, those systems can deny credit when the individual has money available.

A need therefore exists for an improved system for providing payments based on a person's current monetary situation.

### SUMMARY OF THE INVENTION

A payment platform that allows a user to submit a current pay stub and bank account information and, through the system borrow money, shop online, and complete repayment through automated payroll deduction. The platform includes several modules including (i) a mechanism for collecting repayment, (ii) an accounting system for reconciling payroll repayment, and (iii) a lending engine that performs risk analysis, fraud protection, and makes lending decisions. The payment platform can be merged or accessed through existing merchant e-commerce websites and tied into the checkout process.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 illustrates a screen with setup instructions on the left and the employee portal on the right in one embodiment of a payroll deduction system according to the present invention.

FIG. 2 illustrates a user's login screen in the payroll deduction system of the present invention.

FIG. 3 illustrates a user's employee records screen in the payroll deduction system of the present invention.

FIG. 4 illustrates a screen showing the terms and condition that the user must acknowledge in the payroll deduction system of the present invention.

FIG. 5 illustrates an automatic deduction setup screen where a user can control from where deductions are taken.

FIG. 6 illustrates a screen showing the pending discretionary payments.

FIG. 7 illustrates a screen showing the list of automated deductions in the user's account.

FIG. 8 illustrates a setup screen for creating a new automated deduction.

FIG. 9 illustrates a confirmation screen for newly created automated deduction.

FIG. 10 illustrates a notification information screen for a user to provide a contact method for the user to receive notifications of payment.

FIG. 11 illustrates use of the payroll deduction system as part of a purchase process.

FIGS. 12-18 illustrate screens where the system prompts the user to provide payroll, credit card, and banking information that is to be associated with their account.

FIG. 19 illustrates a screen where a user can initiate the deduction from their account.

### DETAILED DESCRIPTION OF THE INVENTION

Repayment Mechanisms

The present invention is configured to work with a multitude of repayment sources so as to maximize the applicability of the system. By utilizing a technologically agnostic system based on a universal repayment framework the system provides the ability to integrate new payroll sources along with existing sources. The system permits the user to select a collection mechanism for repayment of purchases and loans made through the system. Once approved for a loan amount, and a repayment schedule is set, payroll deductions are scheduled for each pay date through a user's selected collection mechanism.

The following repayment mechanisms may be used as part of the repayment module:

Direct Payroll Integration:

The system uses an integrated payroll service provider's API to schedule automated deductions. Some payroll systems do not permit automatic deductions and, as such, the present invention contemplates that user interaction, through use of a graphical user interface provided by the payroll provider, will be required to schedule the deductions for repayment.

ACH (Automatic Cleaning House) Push/Pull:

The system first verifies a user's banking information such as by either an ACH validation or an ACH push by the user of predetermined verification amounts. Once verified, then, based on a user's normal pay schedule, an ACH pull is scheduled to coincide with the user's payroll schedule,

Payroll Deduction:

The present invention contemplates that tools will be provided to businesses to permit streamlining the starting, stopping, and adjustment of scheduled payroll deductions.

Form-Based Payroll Deduction:

The system dynamically generates a digital version of payroll provider specific forms dictating the start, stop, or change of a payroll allotment. An intelligence engine determines which pieces of data to prefill, the format of the form file to be transmitted, the destination of the file, and the transmission mechanism. The methods of transmission most typically utilized are fax, email, physical mail, and SFTP.

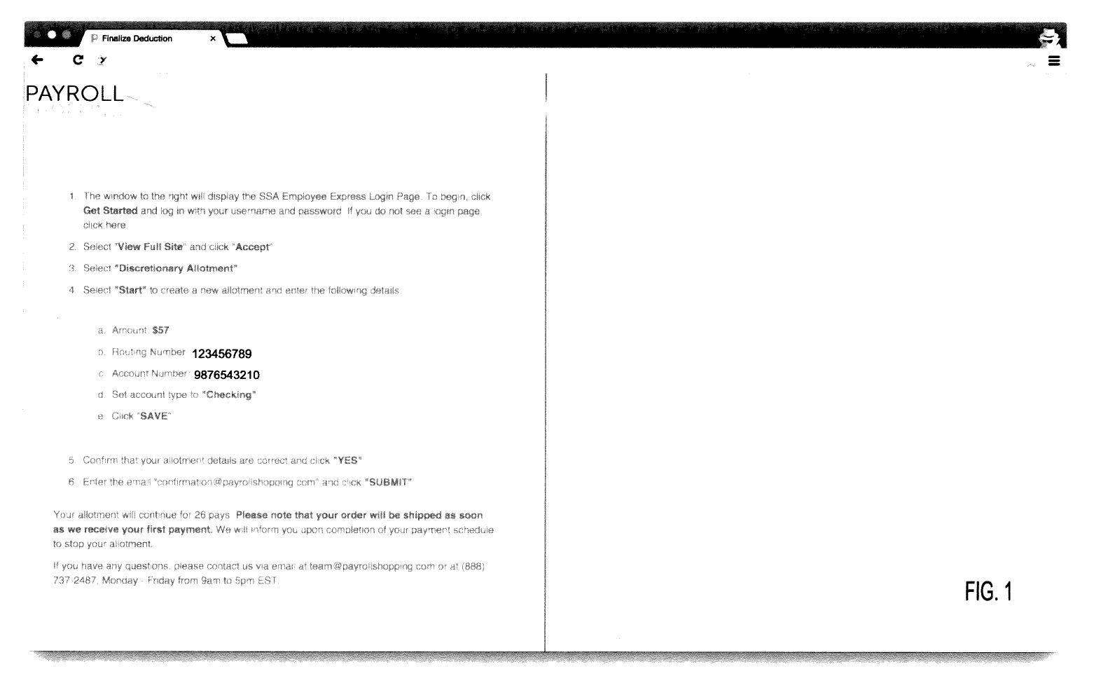

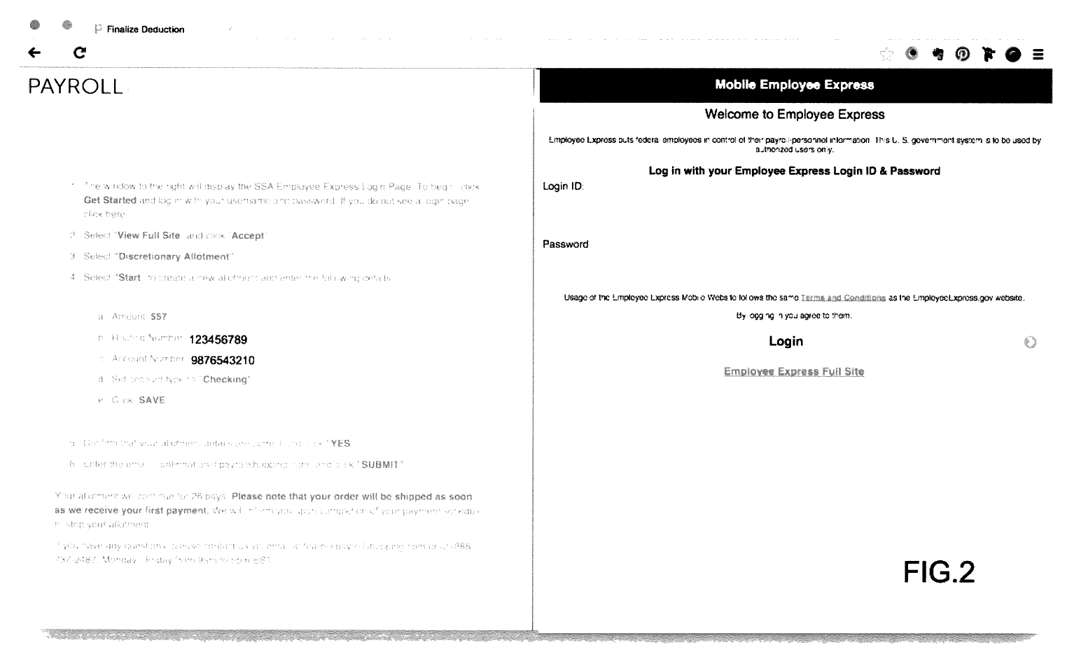

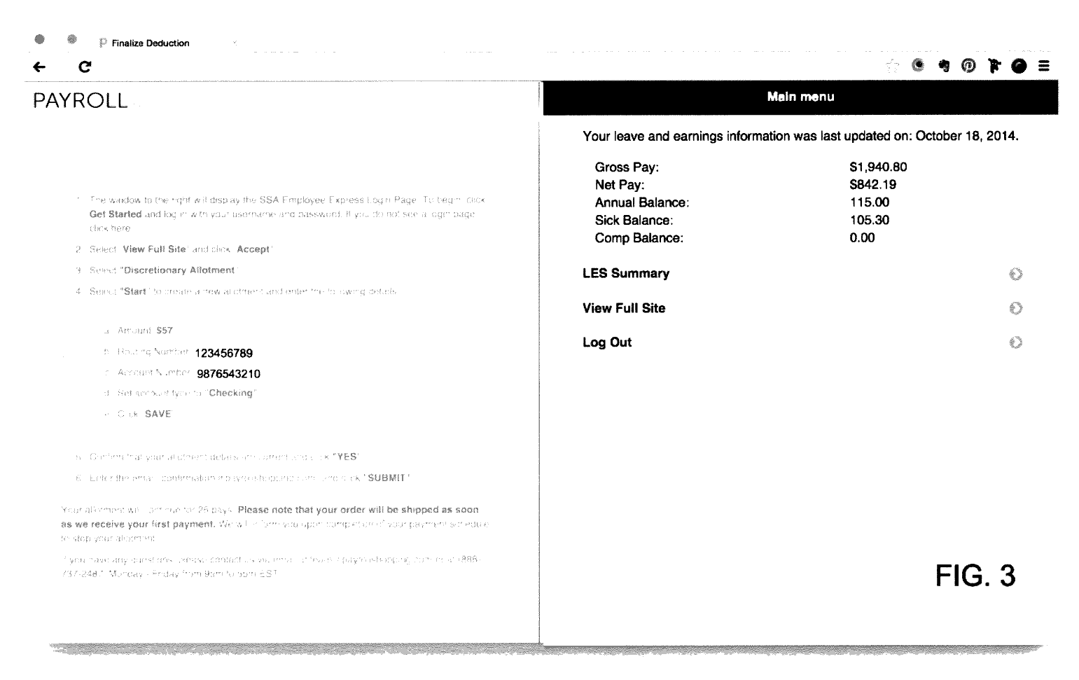

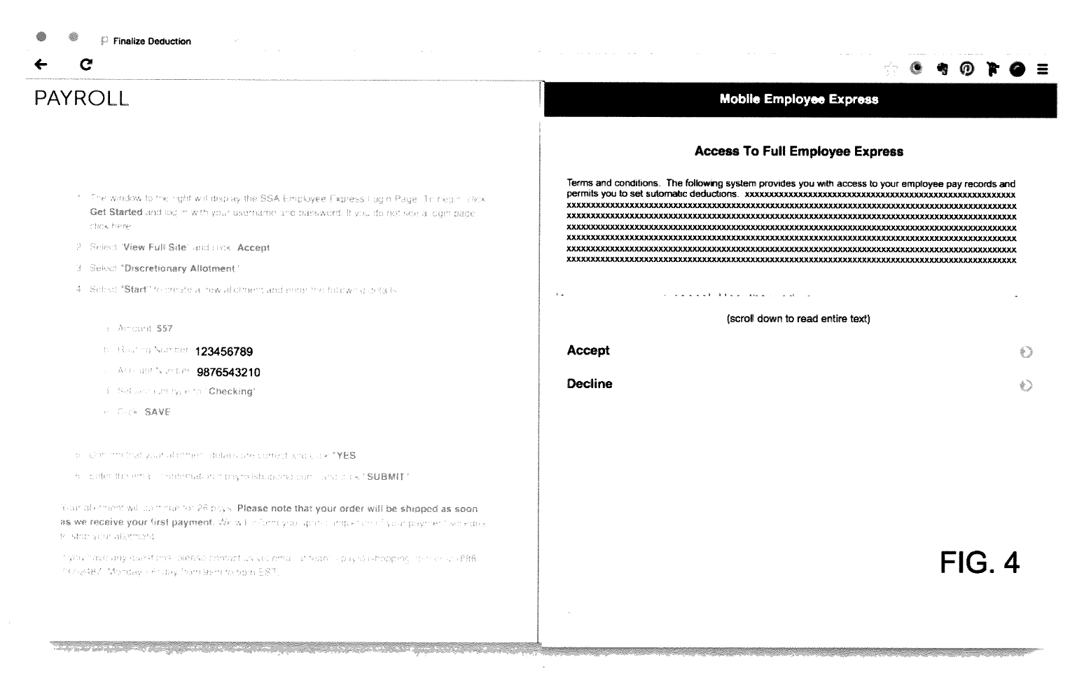

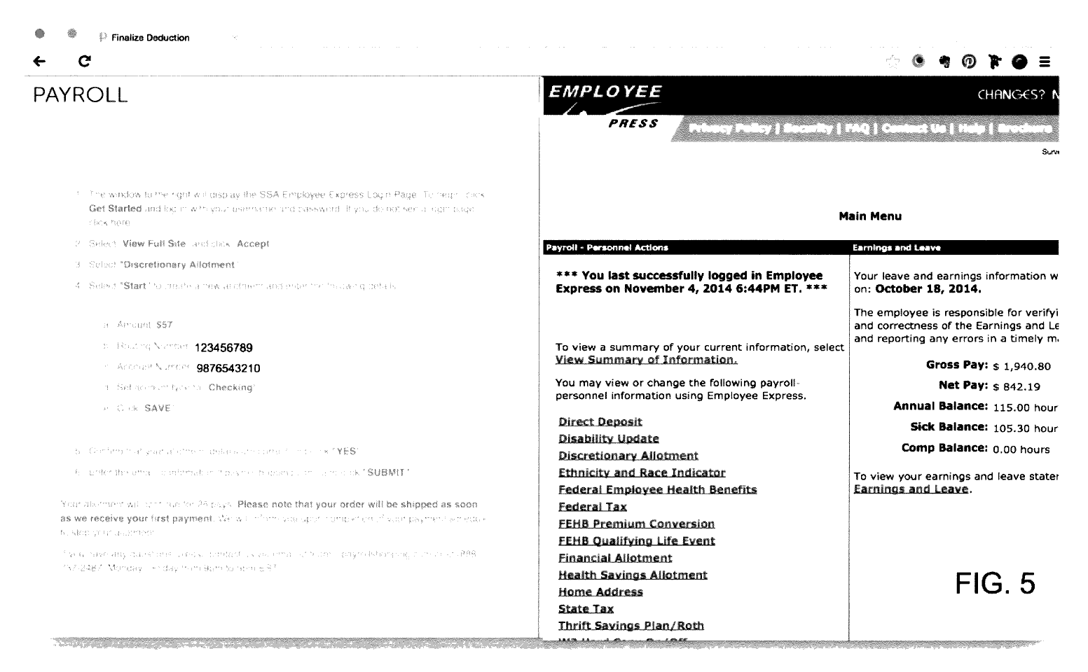

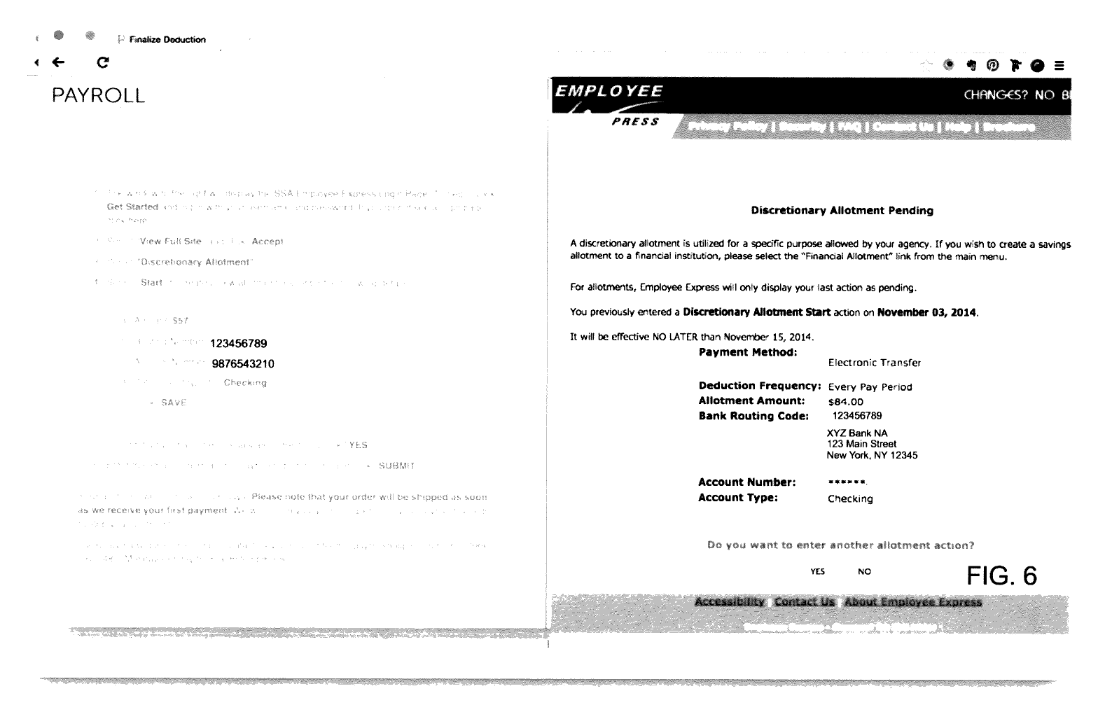

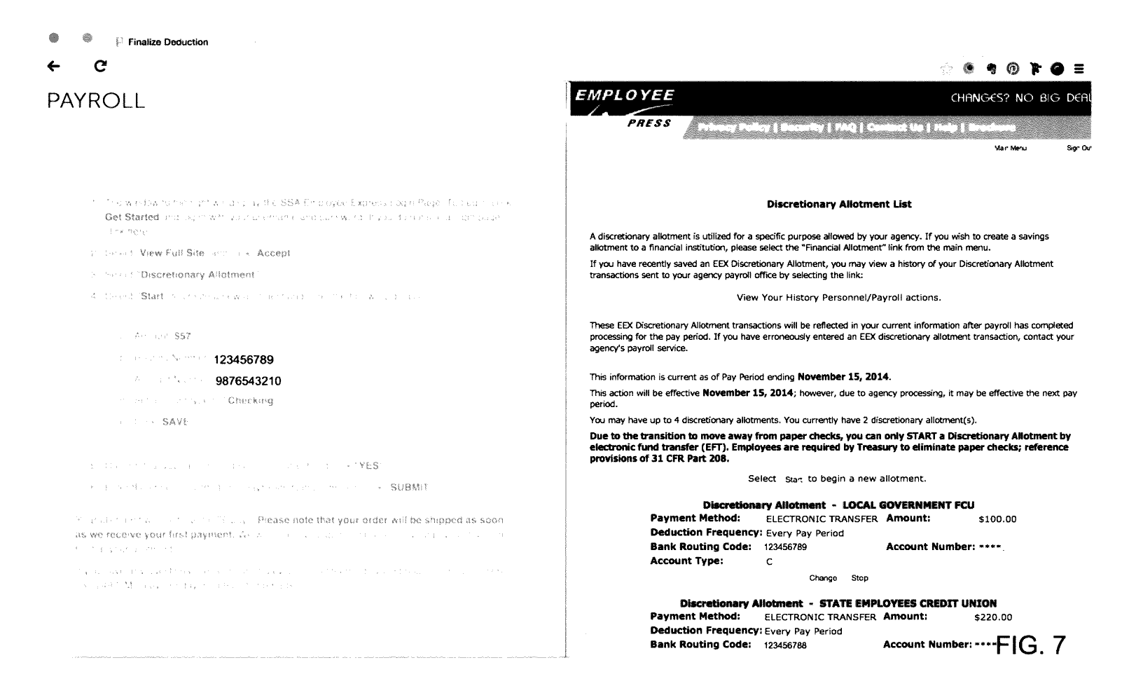

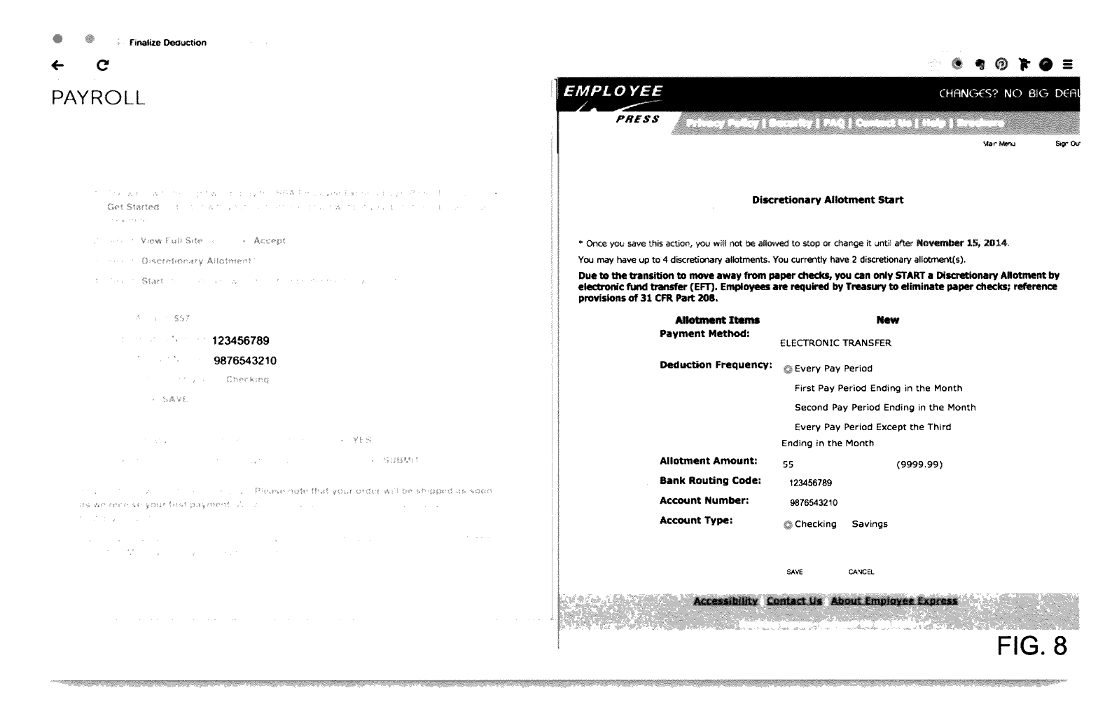

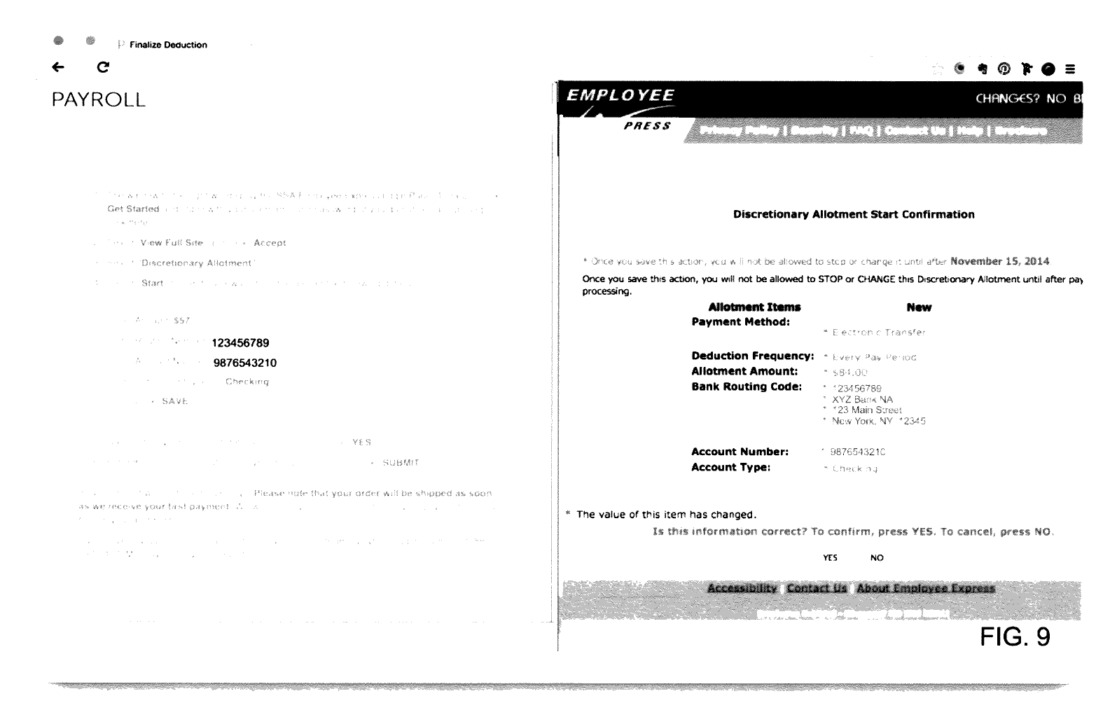

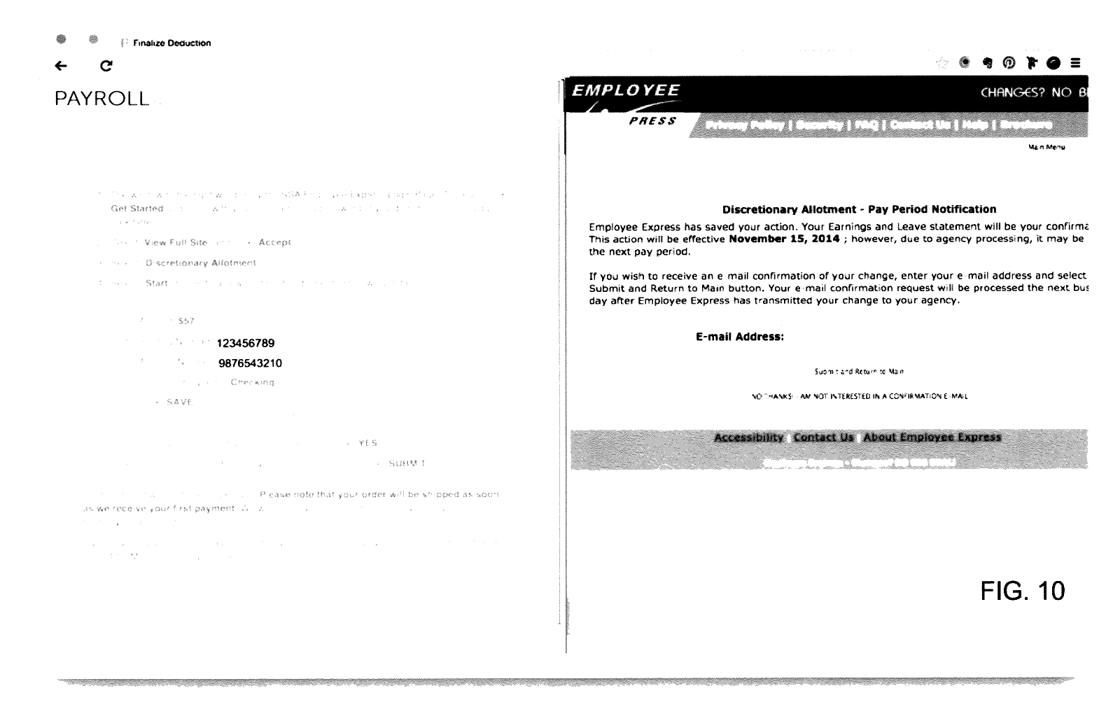

FIGS. 1-10 illustrate one embodiment of a payroll deduction setup screen for use with a business's employee access screen. As shown in FIG. 1, a split screen is shown with the setup instructions on the left and the employee portal on the right. When the employee selects “Get Started”, a login window opens up (FIG. 2). The employee enters their pre-set login information. FIG. 3 illustrates a screen with pulls form the employee's records relevant information regarding the employee gross and net pay. A set of terms and conditions may be provided that the employee is required to accept (such as by scrolling down and depressing an “accept” button) (FIG. 4) before accessing the automated deduction part of the system. Once in the system, the user has the ability to access a “Discretionary Allotment” section of their employee payroll section (FIGS. 5 and 6). In this section the employee can set up their account for an automatic deduction to an account in another bank or to pay loans. The employee creates a discretionary payment including payment method (e.g., electronic transfer), amount, frequency (e.g., every pay period, first pay period in the month, etc.), the bank routing code and account number, and type of account. See, FIGS. 7-10.

Reconciliation

The system includes a reconciliation module to reconcile scheduled repayments from a multitude of sources, including payroll deduction, credit card, and ACH bank account payments. The reconciliation module receives or retrieves data on payroll deductions from multiple merchants and in the case of users with more than one job, multiple payroll sources. After processing and correlating the various payroll deduction sources, an accurate account of repayment is generated, determining any over or underpayments due to user or payroll department errors. This can include end-user or payroll administration input error, refunds through a merchant, or delays in processing payroll. Due to the asynchronous nature of payroll processing, typically a job that is batched during predetermined periods of time, changes to deductions might not occur within an operable window. The reconciliation engine then provides automated system logic and tools for system administrators and lending analysts to adjust payment schedules, handle breaks in repayment, and adjust financing. In order to handle a break, the reconciliation module allows for an adjustment to the repayment that is routed through a user's chosen repayment mechanism. A novel component of the reconciliation engine is the direct tie-in to the lending system. Repayments and reporting are correlated with individual loans from different financing arms and differentiated levels of risk. Data on repayment history, user data, company and demographic datasets, and risk profiles associated with different repayment mechanisms (direct payroll integration, API, ACH, etc.) allow for classifications of different risk tiers for loans. Third-party user and global financial data can be fused with internal data to supplement internal system decisions. This allows for diversified investment tiers for lenders, user-specific lending decisions, fees, and/or interest, as well as financial environment lending decisions.

Risk Analysis

The lending module or engine provides instantaneous lending decisions based on leveraging key data points, an adaptive lending algorithm, and automated validation of employment status. The lending decision process is initialized when an end-user makes a purchase on a third-party merchant's site which is running the present invention. Upon the user or merchant selecting the present system as the desired payment option, the user or merchant uploads the user's most recent paystub. In doing so, the user is applying for a payroll structured loan under the system.

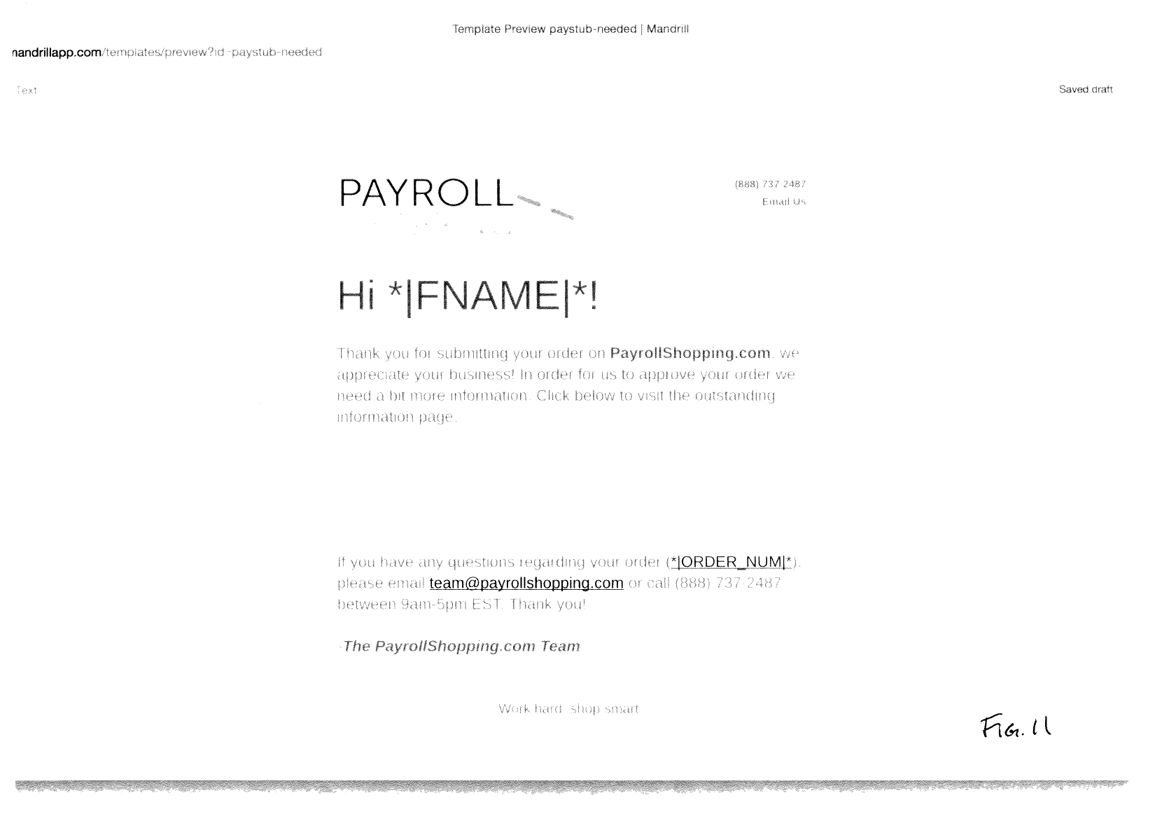

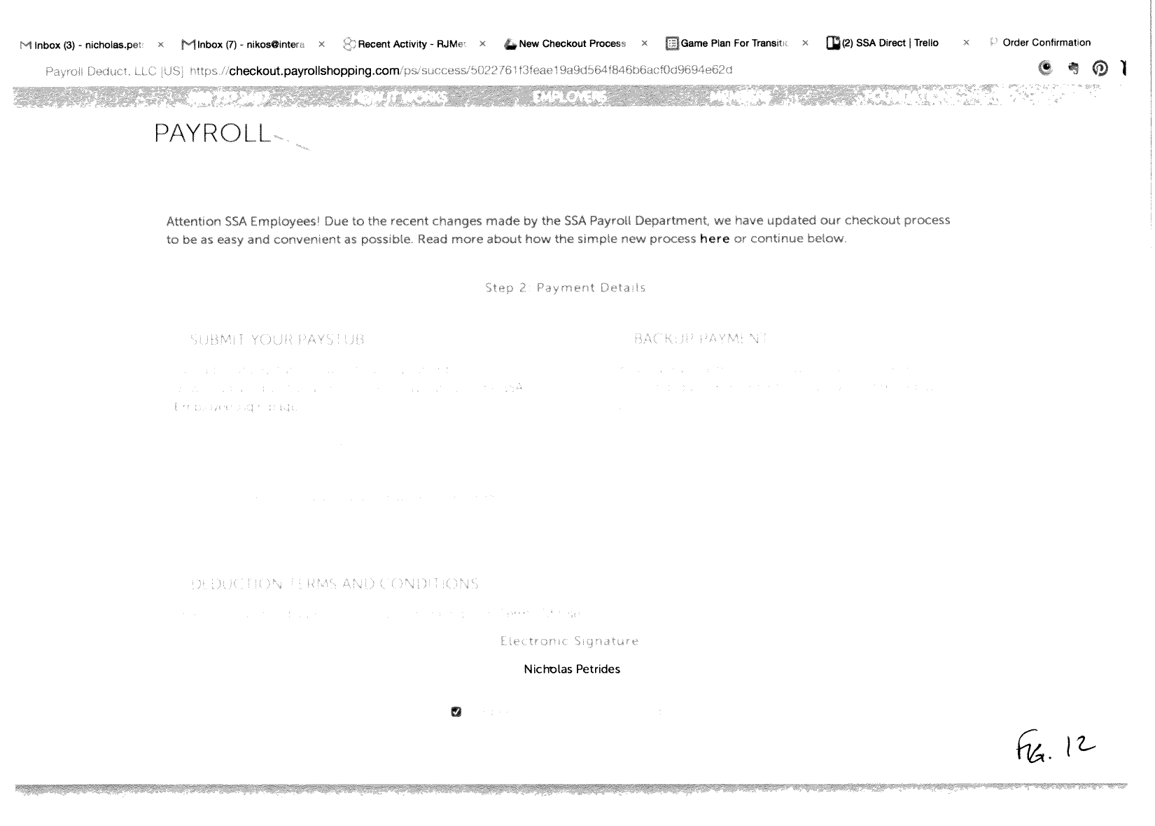

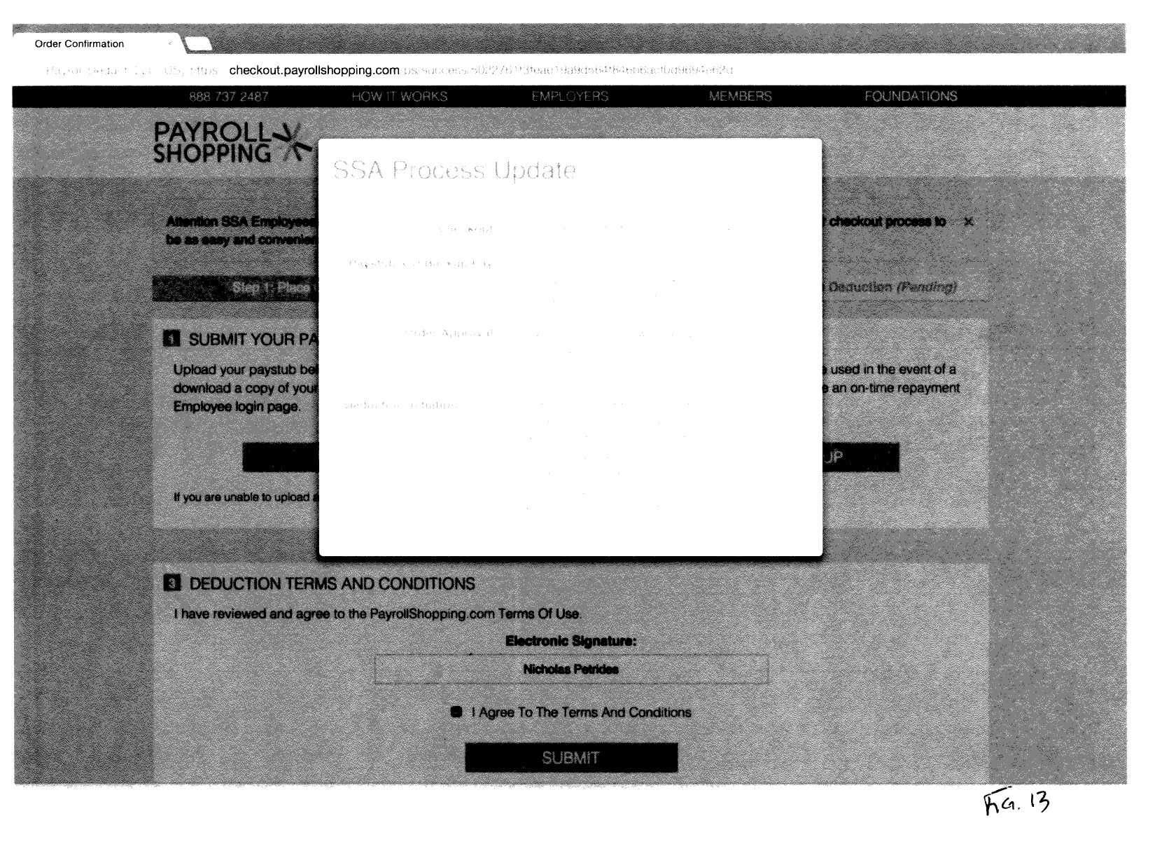

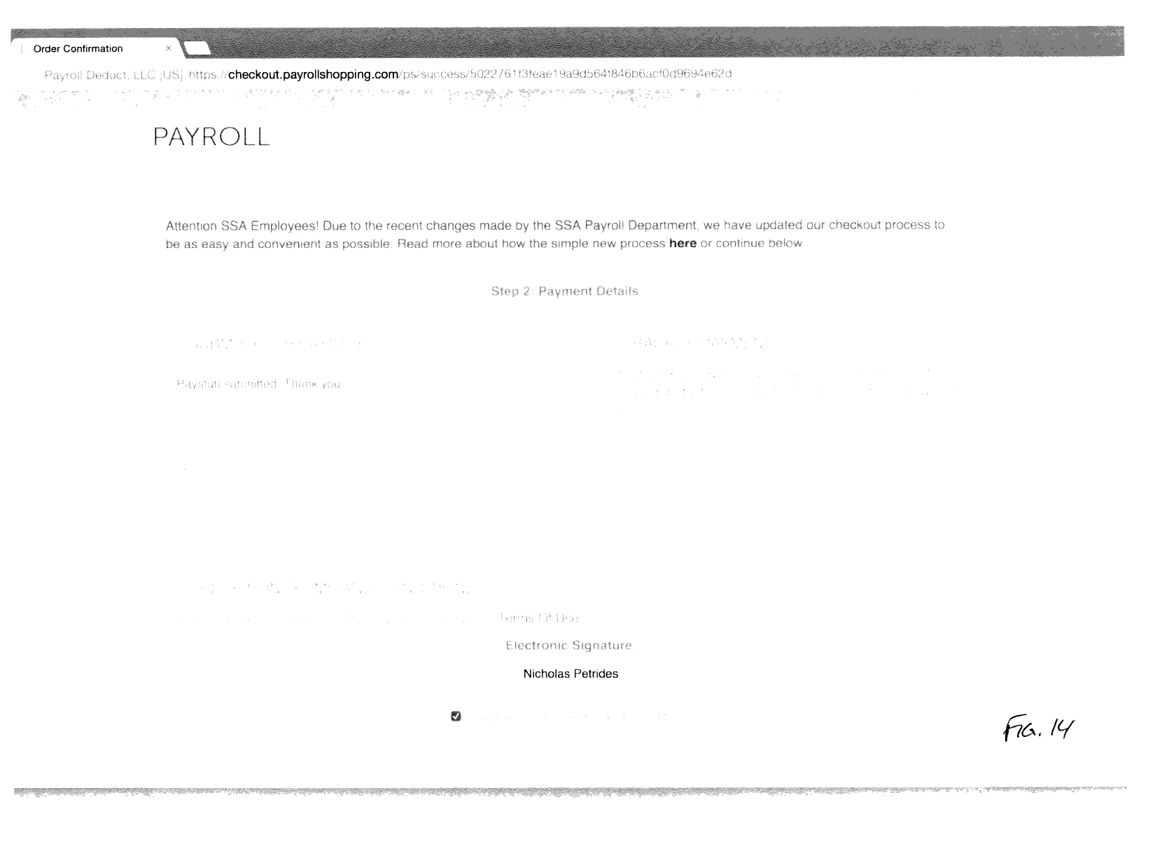

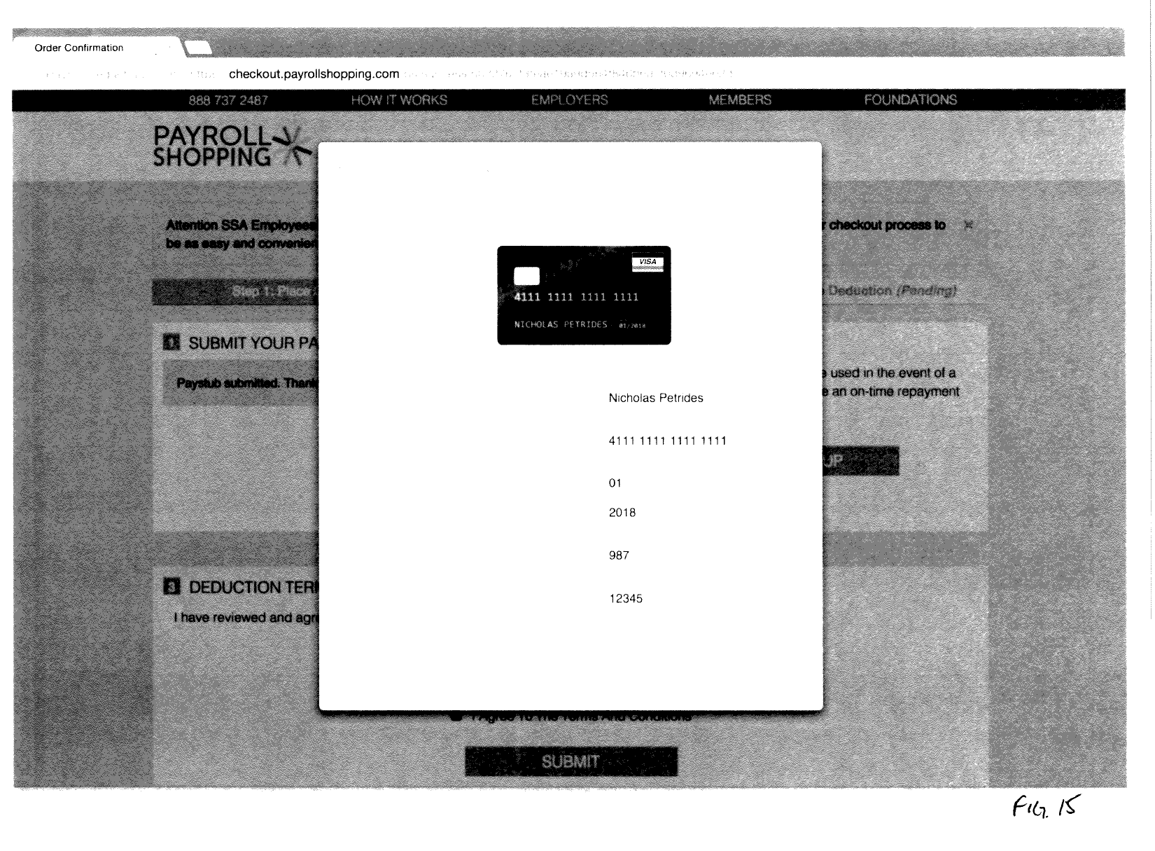

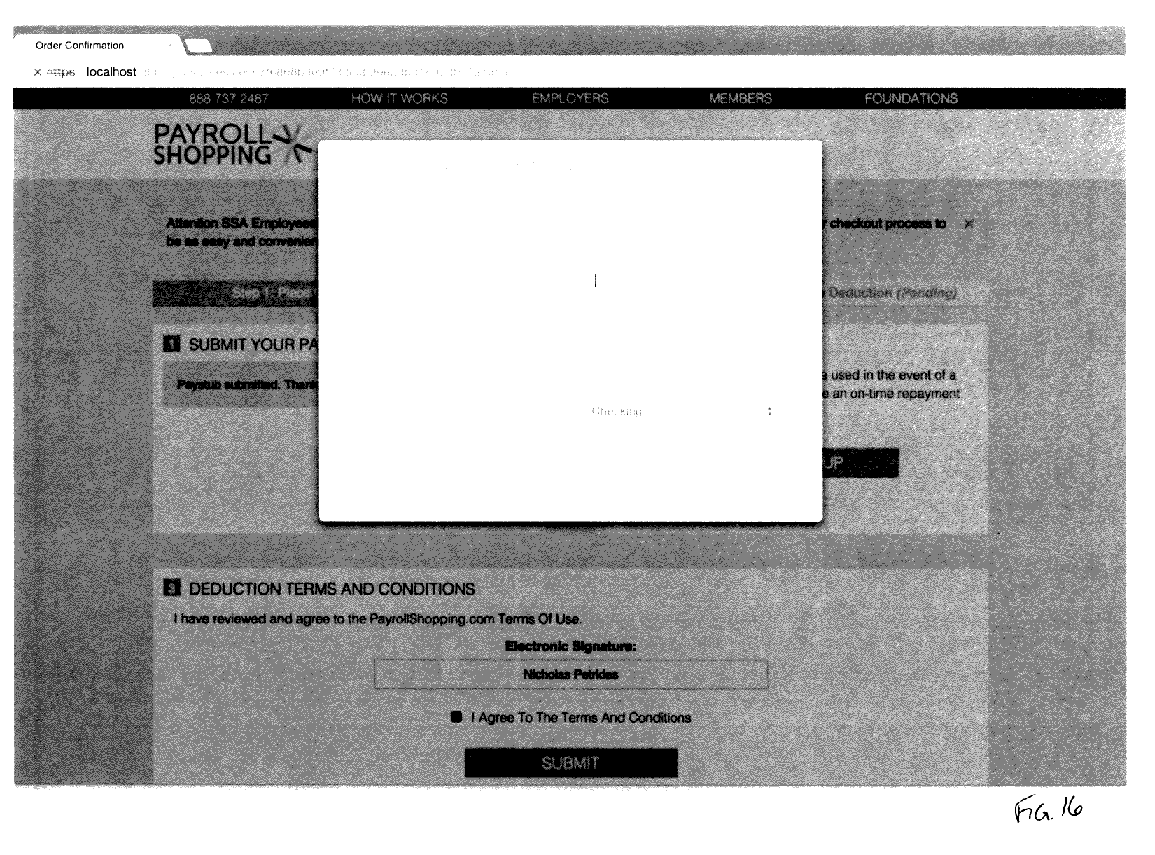

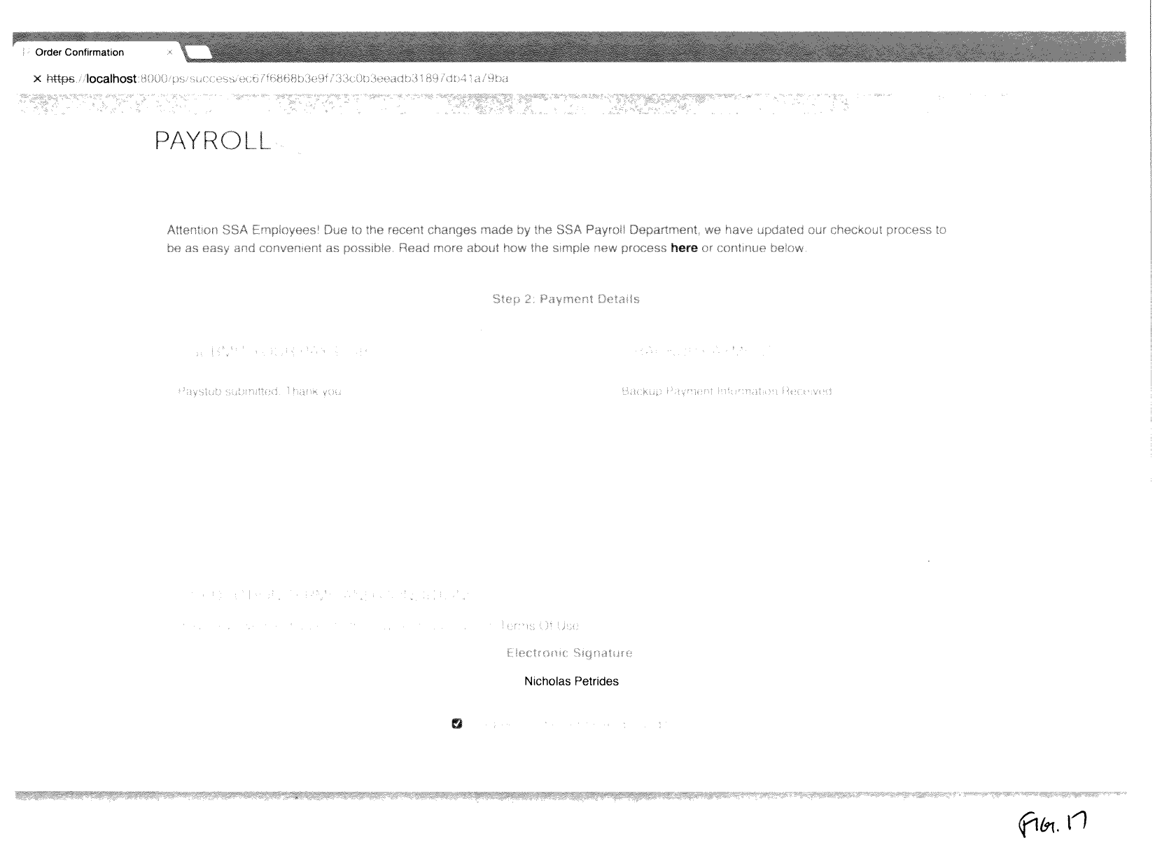

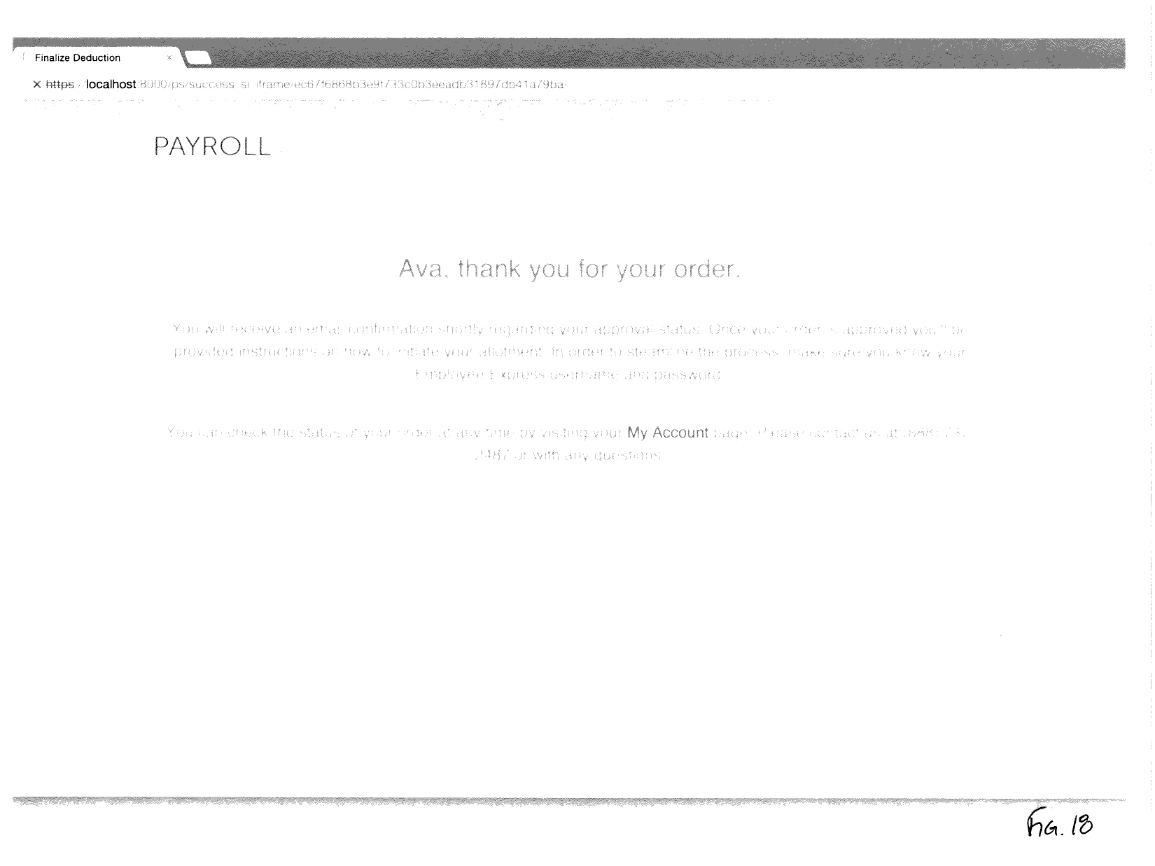

For example, a user may place desired items in their “cart” in a e-commerce cite. At checkout, the user is given the option of selecting the present invention as the desired payment mechanism (FIG. 11). The system then prompts the user to upload their most recent payroll stub (FIG. 12-13). This can be accomplished, for example, by taking a photo of the paystub, or scanning the paystub and uploading it to a specific internet location where the system is running. The system retrieves the digital copy of the paystub and analyses it for relevant data. The system may also request a backup payment mechanism, such as a credit card or bank account), to minimize the risk that the user's primary payment mechanism does not cover the transaction. FIG. 14-18.

Specifically, the system includes analysis software that reviews the digital copy of the paystub for extracting relevant information. The software includes automated image correction which detects features of the image, such as edges and/or quality, for adjusting the digital image. Once the image is adjusted, the software uses an optical image recognition system, such as the Tesseract Optical Character Recognition (OCR) software, to “read” the digital copy of the paystub to extract relevant information, such as salary, net pay, gross pay, employment start date, an employer provided unique identifier for an employee, work and home addresses, tax information, existing deductions, wage garnishments, bankruptcy data, court mandated payments, pay dates, savings/investment data, etc. Once the system has extracted the relevant information from the paystub, the software conducts a loan decision based on that information, and other stored information related to the user. The loan decision can be made within seconds of receiving the paystub information, thus allowing a merchant to continue the checkout process.

More specifically, the analysis software begins by analyzing the quality of the submitted image, applying appropriate image enhancements, and extracting the text from the paystub. For example, if the scanned text is not readable, the system may determine an average angle that makes some of the text readable and then applies that angle to the remainder of the text and checks if all the text is now readable. The software can also detect if the image is upside down or sideways (again, for example, by analyzing a portion of an unreadable image) and can then rotate the entire image.

Through a layout analysis, the relevant data points are identified and a score is assigned to both the readability of the document and the likelihood of fraud. These scores are based on key data from the paystub, historical user and employer data, and external data sources. This includes the aforementioned data points extracted through OCR, a user's repayment and lending history, data sets on user specific demographics such as their company or payroll provider, job history, and position. External data such as public records, phone data, credit history, third-party identity services, and financial market data can augment internal data and influence decisions and parameters.

The grading system is designed upon a framework that permits the factors used in the analysis to be extended as new indicators are determined. This includes new data points that might be identified in the future depending on the information an employer or payroll provider chooses to expose, or data points that have not currently been identified as useful, but in the future prove to provide better insight into lending decisions. If a piece of data included in a paystub was previously unavailable or ignored, but has now exhibited a correlation to borrower behavior, the grading system that analyzes the suitability of data extracted from a paystub can be configured to find this new data point and include its presence into its judgments. The most basic indicator for the suitability of a pay stub image for a lending decision is the readability of the image itself. Poor image quality can be an indicator of tampering and falsification of data points. Identification of a low-quality image as a first step mitigates the risk of incorrectly interpreting key information, whether through an automated or manual process. Also, if the information that is scanned does not make sense (e.g., it is inconsistent), that is another indication that the paystub may be fraudulent.

The system looks at past history for the user (e.g., recent charges, when the paycheck is typically received, etc.) to provide information to assist with the loan decision. For example, if the user typically gets paid on the 15th of the moth, but the scanned image detects a payment on the 1st of the month, it is an indicator that something might be amiss. the system can also look at the current transaction for information. For example, if the “ship to” address on the order is different from the address on the paystub or in the system, it provides an indication that there is might be something wrong with the current transaction.

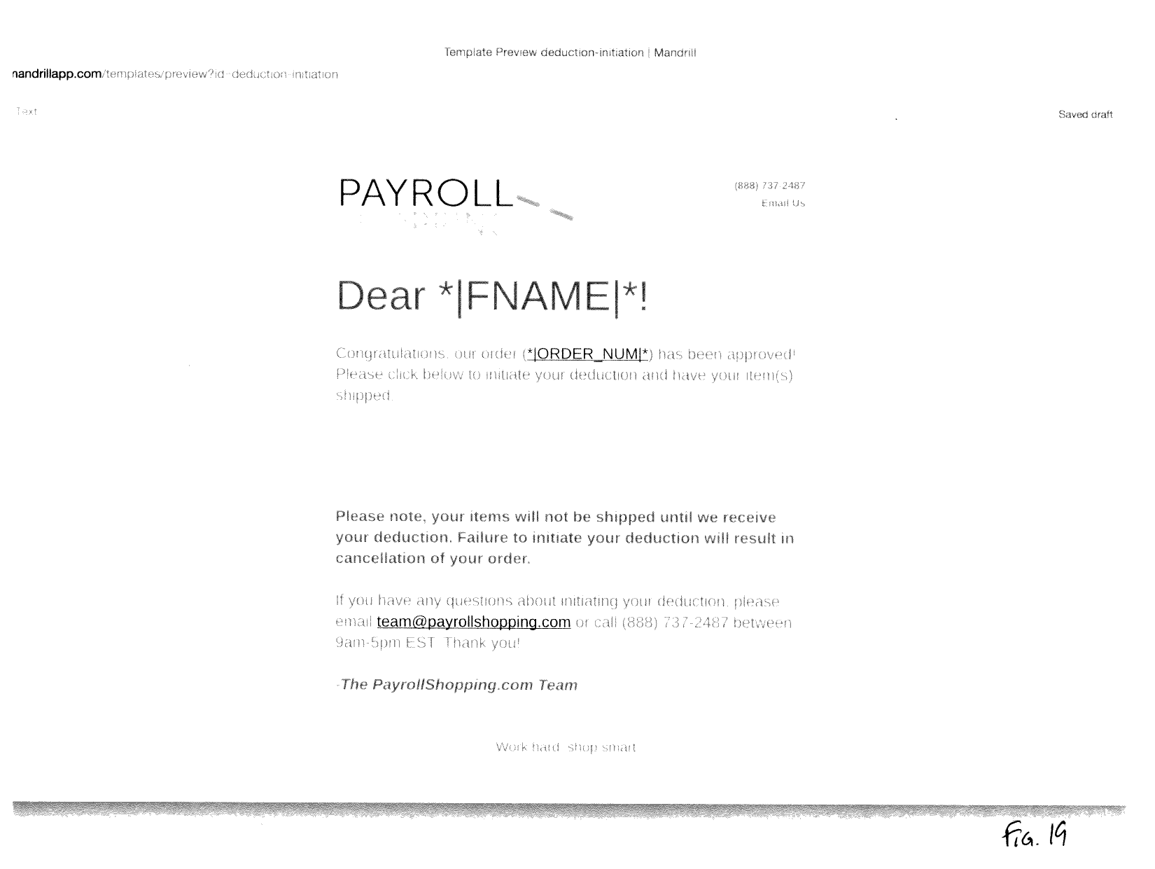

The factors used in the lending process can be adjusted as dictated by environmental variables, including current trends in repayment data, loan amounts, lending risk profile distributions, and concentrations of certain categories or tiers of loans, changes to the grades, historical user data, and the paystub data, as well as the risk desires of the merchant. If significant risk or fraud potential are identified, the lending request is either rejected, or flagged for further review. The level of risk can be adjusted based on the merchant's preferences, and in the event a risk is identified, the merchant may require review of additional factors or data before making a final decision. If the system determined that the risks are below a threshold, indicating that the security level for the merchant has been satisfied, the adaptive lending algorithm determines a spending limit for the end user. The aforementioned data points, notably a user's paystub data, their repayment and borrowing history, demographic data, third-party data sources, and internal and external lending environments, determine a user's spending limit. At a minimum, the program requires a user's gross pay, net pay, salary, and start date. These variables act as parameters in the lending algorithm. The algorithm is set with an initial lending (spending limit) threshold, for example, ten percent (10%) of a user's net pay. From that point, positive and negative indicators are extrapolated from the lending decision data which increase and decrease the final spending limit, respectively. It is contemplated that the initial lending threshold can be adjusted based on the merchant's or lenders degree of risk tolerance. Pieces of data, correlation between data points, and patterns matching specific behaviors are associated with positive or negative increases in spending limits. This calculation adapts based on which pieces of data the system has for each with the presence of more data leading towards a lending decision with higher confidence and a potential for a higher spending limit. If a critical piece of data is missing, it will have an adverse effect on a spending limit (such as reducing the credit limit or indicating that the individual is a potential credit risk, even if other data suggest a higher credit limit. If the purchase being made through the third-party merchant is within the spending limit, the order is approved and the process proceeds to the financing software. FIG. 19.

Merchant Integration

The system can be integrated into the purchasing process through many different mechanisms. In one embodiment, the system can be provided as a plugin to conventional e-commerce platforms, such as the Magento e-commerce platform, allowing a user to select the lending and payroll deduction mechanisms of the present invention as the payment mechanism and will allow for the merchant to have access to reporting and configuration tools. It is also envisioned that a dedicated button can be integrated into the checkout choices for a user to select.

When checking out on an ecommerce merchant's site, an active user of the system will be able to see prices for items detailed in monetary amounts per their individual pay period. Through an API call to the system, a merchant's site will be able to submit an item's cost and based on the pay schedule, risk level, and duration of the loan, receive the amount per paycheck that item would cost. This data can be retrieved while a user shops on a merchant site that is integrated with the system, displaying the cost per deduction on the page for each item or in their cart during checkout on an ecommerce merchant site. Alternately, the merchant's site can redirect the user's online experience to a dedicated site that runs the present software system. The site would be connected to the merchant's site such that once the lending has been completed, the purchase is then consummated. When checking out this way, the necessary information, including their current paystub, is uploaded to the dedicated site and processed as described above. The lending decision is made and returned to the merchant, allowing for a decision as to whether or not to process the current order. If a user is not approved, the user can continue their purchase with another payment mechanism or adjust their order based on feedback from system, i.e. lower their order total to be within a certain range (spending limit) that the system can provide to the merchant and/or user. If a user has not registered with the system, the user will be directed through a registration process. The checkout button can be constructed using conventional AJAX/Javascript and integrated so that a user will not have to leave a merchant's site during checkout.

In a preferred embodiment, the invention is implemented as part of a computer based software system that is designed to operate over a network, such as an internet or cloud based system. Some or many of the functional modules described above may be stored and operate from a cloud storage system, the user's computer, the merchant's computer system and/or an intermediary's computer system.

The program may be implemented or performed with a general purpose processor, a digital signal processor, an application specific integrated circuit, a field programmable gate array or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices.

Further, the steps and/or actions of program or method described in connection with the aspects disclosed herein may be embodied directly in hardware, in a software module executed by a processor, or in a combination of the two. A software module may reside in RAM memory, flash memory, ROM memory. EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an application specific integrated circuit. Additionally, in some aspects, the steps and/or actions of a method may reside as one or any combination or set of instructions on a machine readable medium and/or computer readable medium, which may be in any convention physical form.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail.

Finally, the use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

1. An payment platform system for use in payment of purchases through payroll deduction, the payment platform system comprising:
a collection module for permitting a user to submit a pay stub and bank account information, the module storing the information in association with a user's account;
an accounting module for reconciling purchases made by a user against a user's payroll information and banking information associated with the user's account, the accounting module retrieving data from a plurality of merchants using the system, and retrieving recent financial information on the user;
a lending engine that performs risk analysis, fraud protection, and makes lending decisions; the lending engine analyzing a user's account, including purchase history and financial information associated with the user, the lending engine including the ability to permit an authorized merchant to control risk levels associated the merchant; the lending engine making lending decisions based on analysis of the risk levels for a particular merchant; and
wherein the system permits a user to borrow money, shop online, and complete repayment through automated payroll deduction.

2. The payment platform system of claim 1, wherein the system is part of the check-out section of a merchant e-commerce website.

3. The payment platform system of claim 1, wherein the collection module permits a user to select the option of making payments from at least a paystub, a payroll deduction, or a bank account.

4. The payment platform system of claim 3, wherein the collection module permits a user to input information on related to their pay including pay schedule and, bank routing information for making wired payments, and wherein the system verifies the banking information, and wherein the system sets timing of repayment of loans based on a user's pay schedule.

5. The payment platform system of claim 1, wherein the lending module retrieves repayment information from the accounting module for determining an updated risk assessment of the user.
